(19) United States
(12) Patent Application Publication
(10) Pub. No.: US 2025/0225830 A1
(43) Pub. Date: Jul. 10, 2025

(54) INTELLIGENT LOCKING SYSTEM WITH ELECTRONICAL IDENTIFICATION FOR A DANGEROUS ITEMS REPOSITORY

(71) Applicant: PRAGMA Etimos S.r.l., Latina (LT) (IT)

(72) Inventors: Gaetano Lo Presti, Latina (LT) (IT); Michelangelo Di Stefano, Reggio Calabria (RC) (IT); Giorgio Rubiu, Aprilia (LT) (IT); Fabio Vincenzo Colacino, Anzio (RM) (IT)

(73) Assignee: PRAGMA Etimos S.r.l., Latina (LT) (IT)

(21) Appl. No.: 18/404,608

(22) Filed: Jan. 4, 2024

(51) Int. Cl. G07C 9/00

(52) U.S. Cl. CPC G07C 9/00563

(57) ABSTRACT

An intelligent locking system configured to be associated to a controlled working repository comprises a locking element apt to physically prevent a proper working of the controlled working repository, and a user recognition device apt to recognize an authorized user, the locking element being triggered into a safe use mode only upon receiving an authorization command from the user recognition device, the safe use mode releasing a plurality of dangerous item stored into the controlled working repository.

### BACKGROUND

### Technical Field

The present disclosure relates to an intelligent locking system.

The disclosure particularly, but not exclusively, relates to an intelligent locking system with electronical identification for a dangerous items repository for preventing access to dangerous items, in particular for a magazine of a firearms and the following description is made with reference to this field of application for convenience of explanation only.

### Description of the Related Art

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

As it is known, there are items that should be safely accesses only upon authorization as well as tools or devices that should be handled only by trained personnel.

Unauthorized access to such dangerous items or devices can cause accidents having very serious consequences for the people involved, leading even to death.

This is the case, for example, of unauthorized access to dangerous tools, such as nail guns, soldering irons, welders, caustic and/or poisonous material dispensers, or devices such as firearms or bows or underwater rifles, to name few, which can injure, even fatally, a user who comes into possession of them but does not fully understand how they work.

Serious if not catastrophic consequences can also occur in the event that a felon gets into possession of dangerous items, tools or devices.

In relation to firearms, there are dramatically almost daily reports about injuries or killing of people due to gunshot wounds, these incidents largely involving young people, in particular under the age of 24, usually hit by someone having a same age.

Over the years, various mechanical and electronic solutions have been developed aimed at preventing powering on tools, when dangerous, in particular firearms, or accessing to places storing such dangerous tools, such as, for example, increasingly unassailable locks, which combine mechanical devices with a high level of safety, such as using non-duplicable numeric coded keys as well as software protection measures, such as biometric or voice recognition systems.

Unfortunately, all of these solutions are not tamper-proof, especially for a felon with a strong motivation.

### BRIEF SUMMARY

An embodiment of this disclosure is directed to an intelligent locking system with electronical identification apt to be associated to a repository of dangerous items for preventing access to the same, the intelligent locking system being able to stop the delivering of the dangerous items such as nails, soldering metal, caustic and/or poisonous materials, arrows or bullets from a corresponding repository or dispenser or magazine, in this way overcoming the problems tied to the prior art solutions.

According to an aspect of the disclosure, the intelligent locking system combines a mechanical locking element with an advanced user recognition device apt to recognize an authorized user, in particular a biometrical recognition device (using biometrical data such as fingerprints, voice or facial features for identifying an authorized user) or an electronic recognition device (using a magnetic, RFID (Radio Frequency IDentification) or NFC (Near Field Communication) token), the mechanical locking element being released only after the authorized user is identified, unlocking the repository and freeing the dangerous items such as nails, soldering metal, caustic and/or poisonous materials, arrows or bullets stored therein.

In particular, according to an aspect of the disclosure, the intelligent locking system is configured to be associated to a controlled working repository and comprises a locking element apt to physically prevent a proper working of the controlled working repository, and a user recognition device apt to recognize an authorized user, the locking element being triggered into a safe use mode only upon receiving an authorization command from the user recognition device, the safe use mode releasing a plurality of dangerous item stored into the controlled working repository.

According to another aspect of the disclosure, a controlled working repository comprises a plurality of dangerous item; at least a case having a closed end and an open end and being apt to house the plurality of dangerous item; and an intelligent locking system wherein the intelligent locking system comprises a locking element apt to physically prevent a proper working of the controlled working repository; and a user recognition device apt to recognize an authorized user, the locking element being triggered into a safe use mode only upon receiving an authorization command from the user recognition device, the safe use mode releasing the plurality of dangerous items.

According to a further aspect of the disclosure, a magazine of a firearm comprises a plurality of bullets; at least a case having a closed end and an open end and being apt to house the plurality of bullets; a fixed base; elastic means; a follower associated to the fixed base by the elastic means, wherein the magazine stores the bullets in at least a column starting from the follower and the elastic means are able to move the follower and thus the bullets towards the open end of the case; and an intelligent locking system including a locking element apt to physically prevent delivery of the bullets; and a user recognition device apt to recognize an authorized user, the locking element being triggered into a safe use mode only upon receiving an authorization command from the user recognition device, the safe use mode releasing the plurality of bullets.

The characteristics and advantages of the intelligent locking system, the controlled working repository and the magazine according to the disclosure will be apparent from the following description of embodiments thereof given by way of indicative and non-limiting example with reference to the annexed drawings.

### BRIEF DESCRIPTION OF THE SEVERAL VIEWS OF THE DRAWINGS

FIG. 1 schematically shows an intelligent locking system according to an embodiment of the disclosure apt to be integrated into a repository of dangerous items;

FIGS. 2A and 2B schematically shows a repository of dangerous items, in particular a magazine including a plurality of bullets, comprising an intelligent locking system according to an embodiment of the disclosure; and

FIG. 3 schematically shows a user holding a firearm including a magazine provided with an intelligent locking system according to an embodiment of the disclosure.

### DETAILED DESCRIPTION

With reference to such figures, an intelligent locking system is described which finds particular application in limiting the working of a repository of dangerous items, such as nails, soldering metals, caustic and/or poisonous materials, arrows or bullets, only upon recognition of an authorized user. In the following, reference will be made generically to a controlled working repository to indicate a repository which is protected by the intelligent locking system according to the present disclosure, i.e. to which the working is allowed only after authorization.

Here and below, relative terms like “top”, “bottom, “upper”, “lower”, and similar ones are intended as referring to the illustrations given in the drawings, for sake of conciseness. Similarly, terms like “left”, “right”, “above”, “below”. and similar ones are used still with reference to the drawings.

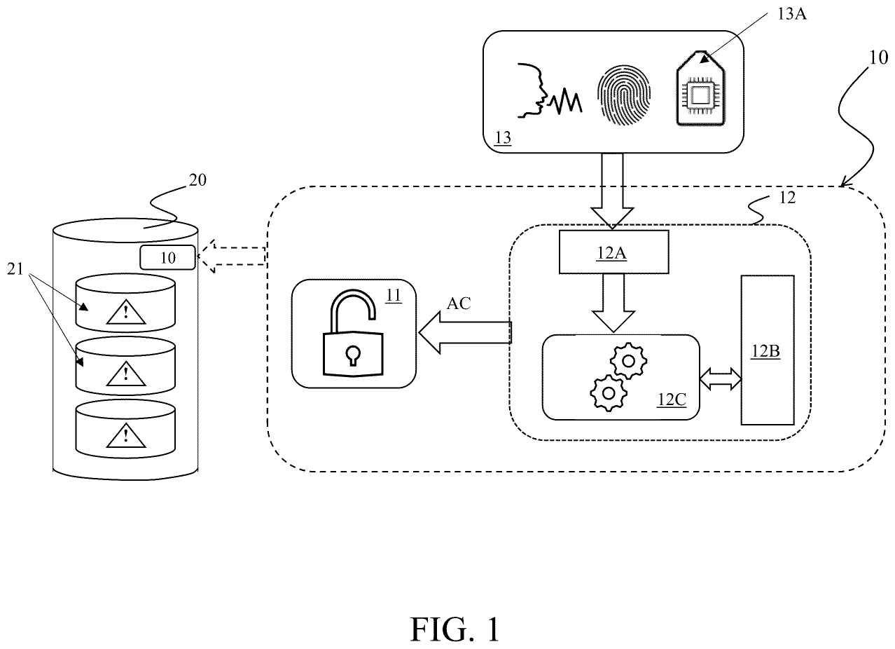

More particularly, with reference to FIG. 1, the intelligent locking system 10 includes a locking element 11 and a user recognition device 12 coupled one another.

According to an embodiment of the disclosure, the locking element 11 is able to physically prevent the working of a repository of dangerous items associated with the intelligent locking system 10 for safety reasons. The locking element 11 can be removable or integral with the controlled working repository 20 itself and can be equipped with an independent battery or associated with an internal energy source of the controlled working repository 20. More particularly, the locking element 11 can be a separately produced element which is associated to a repository, such as a repository of a tool or a magazine of a weapon, already on the market, making the same a controlled working repository 20.

In a preferred embodiment of the disclosure, the user recognition device 12 is a biometric identification engine comprising at least one between a voice recognition device and a fingerprint scanner, being able to recognize an authorized user or a plurality of authorized users by means of their biometric data, being user identification data 13, for instance a voice command and/or fingerprints being previously stored in the user recognition device 12. The stored voice command and/or fingerprints are thus a certified recognition key of the authorized user.

Alternatively, the user recognition device 12 is an electronic device able to receive and verify user identification data 13 from an NFC or RFID tag 13A.

In particular, the user recognition device 12 comprises an interface 12A able to collect the user identification data 13, from a user or a tag, and a memory unit 12B, able to store data of authorized user(s). According to an embodiment, the interface 12A of the user recognition device 12 may comprise a microphone able to collect a voice command and/or a fingerprint scanner and/or an NFC-RFID receiver, in case coupled and interacting with one another.

The user recognition device 12 further comprises an engine 12C being connected to the interface 12A and to the memory unit 12B and able to compare the collected user identification data 13 with the stored data so as to identify a user as an authorized user, being for instance the owner of the intelligent locking system 10.

The user recognition device 12 can be integrated within the controlled working repository 20 or associated thereto.

Only after the user recognition device 12 has positively identified an authorized user, an authorization command AC is provided to the locking element 11 so as to unlock it by triggering a safe use mode. The authorization command AC could be in the form of a binary signal having a first state “access authorized” and a second state “access denied”.

In case of a voice recognition as user recognition device 12, a specific voice command, for instance a preset word or sequence of words, could be required from the user in order to unlock the locking element 11. However, the authorization command AC is only provided by the user recognition device 12 to the locking element 11 when the specific voice command comes from a stored voice, i.e. an authorized user, i.e. after the engine 12C of the user recognition device 12 has recognized a so-called “voice print” of the user, making it impossible for any other individual to grant access to the controlled working repository 20 protected by the intelligent locking system 10 by simply pronouncing the specific voice command, i.e. the preset word or sequence of words, thus realizing a two-keys protection mechanism.

In particular, the memory unit 12B can comprise unique voice print(s) being obtained by a recording of the authorized user voice(s), for instance a minute long voice recording to be used by the engine 12C in order to recognize authorized user(s) having collected the user identification data 13, in particular a specific voice command.

The engine 12C may use Machine Learning and Deep Learning algorithms to identify the authorized user(s). More particularly, in case of a voice recognition device as user recognition device 12, the engine 12C may provide for eliminating the background sounds so as to enhance the recognition of the voice of the user.

In a preferred embodiment, the user recognition device 12 is a portable device, for instance a mobile phone provided with an interface 12A for user identification data 13, such a microphone and comprises radio connection means to the locking element 11 in order to provide the authorization command AC.

Moreover, a combination of more than one user identification data 13 can be required to authorize the working of the controlled working repository 20 by unlocking the locking element 11, for instance, a biometric data such as a voice and/or a fingerprint of an authorized user should be received along with a signal from the NFC or RFID tag 13A for triggering the authorization command AC, thus realizing a two-or even multiple-keys protection mechanism.

Suitably, the locking element 11 is configured to prevent the controlled working repository 20 to properly work, for example to prevent delivery of dangerous items 21 stored therein, such a delivery being authorized only after recognition of the user as an authorized user by the user recognition device 12 which transmit the authorization command AC to the locking element 11, as previously explained.

In its general form, the locking element 11 1 comprises an electromechanical lock 15 driven by the authorization command AC issued by the user recognition device 12, the electromechanical lock 15 being associated with a release mechanism 14 of the dangerous items 21 stored in the controlled working repository 20, as further explained below with reference to a preferred embodiment.

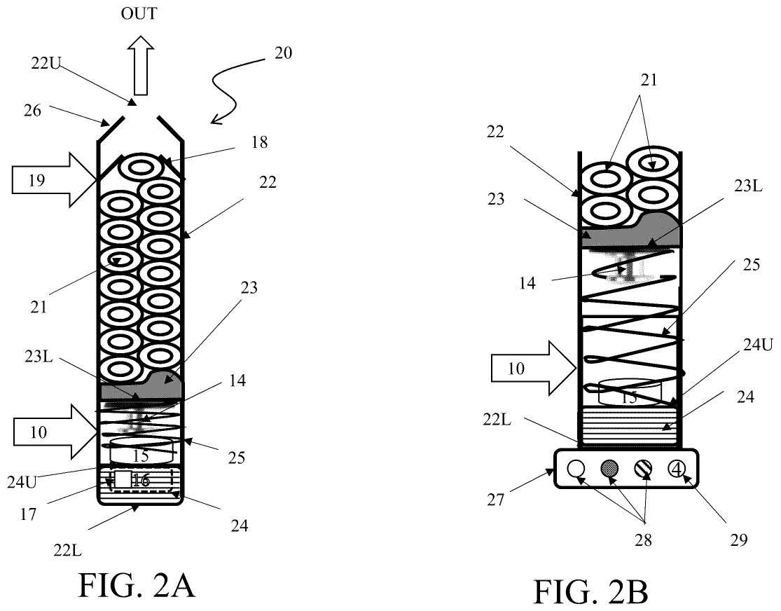

According to such a preferred embodiment, as shown in FIGS. 2A and 2B, the intelligent locking system 10 is associated to a magazine of a firearm, such a magazine being the controlled working repository 20.

More in particular, the magazine 20 comprises a plurality of dangerous items in the form of cartridges or bullets 21 included in a box or case 22 having a first or upper open end 22U and a second or lower closed end 22L. The magazine 20 stores bullets 21 in a column, either one above the other or in staggered zigzag fashion, such a double-column mode being usually preferred since in this way more bullets 21 can be stored in the space within the case 22, as shown in FIG. 2A.

The magazine 20 also comprises a follower 23 connected to a fixed base 24 by means of elastic means, in particular a spring element 25 being able to move the follower 23 and thus the bullets 21 towards the upper open end 22U of the case 22, such an upper open end 22U being provided with elastic retaining means being able to keep the dangerous items 21 in the controlled working repository 20 and being in the form of elastic closing lamellas 26, maintaining the bullets 21 within the case 22 against a gravity force, in case the magazine 20 is rotated with its upper open end 22U directed toward ground. The elastic closing lamellas 26 are opened by a suitable force applied by the spring element 25, so allowing a bullet 21 to be loaded into a barrel chamber of a firearm comprising the magazine 20.

Suitably according to the disclosure, the intelligent locking system 10 comprises a release mechanism 14 being in the form of a key element, such as a piston, associated to the follower 23, in particular in correspondence of a lower face 23L thereof. The release mechanism 14 is coupled to an electromechanical lock 15, chosen among an electronic, electromagnetic or magnetic lock, also simply indicated as lock 15, attached to an upper face 24U of the fixed base 24.

In particular, the lock 15 is able to retain the key element 14 in a lower position, i.e. at the upper face 24U of the fixed base 24 thus preventing the follower 23 to move toward the upper end 22U of the case 22. In this position, the spring element 25 is in a compressed form.

The lock 15 is suitably commanded by the authorization command AC provided by the user recognition device 12, which is able to unlock the lock 15 and allow the movement of the key element 14 thus releasing the follower 23 connected thereto, i.e. starting a proper working of the magazine 20 and thus of a firearm comprising the same.

In this way, the key element 14 and lock 15 form the locking element 11 of the intelligent locking system 10 driven by the authorization command AC provided by the user recognition device 12. A circuital block 16 comprising or connected to the user recognition device 12, provided with a battery 17, can be inserted within the fixed base 24 of the magazine 20 or in a portion of the case 22 adjacent to such a fixed base 24.

According to another embodiment, a plurality of mechanical locks 15 are provided for each of the bullets 21, so as to prevent their movement. In particular, each of the lock 15 comprises a spring and a barrel being activated by the authorization command AC so as to freeing the bullets 21 within the case 22 of the magazine 20.

The presence of the intelligent locking system 10 within the magazine 20 can thus reduce the storage capacity of the magazine 20, i.e. the total number of bullets 21 that can be stored therein. Alternatively, an additional space can be provided in the case 22 to house the intelligent locking system 10, the total length of the magazine 20 being increased proportionally.

According to an alternative embodiment, the magazine 20 can be provided with interlocking features being able to interact with corresponding elements provided in a handle of a firearm housing the magazine 20, in a male-female or clipping configuration (not shown in the figures). In this way, only a magazine provided with specific interlocking features can be inserted into the firearm, having a handle provided with corresponding interlocking features. So, the firearm becomes a controlled working device thanks to the intelligent locking system 10 of the magazine 20 that can be unlocked only by authorized users.

The intelligent locking system 10 can also comprise supplemental lamellas 18, being provided within the case 22 of the magazine in correspondence of a position of a last bullet 21 when the spring element 25 is compressed, so as to avoid any undesired movement of the bullets 21 toward the upper open end 22U of the case 22 of the magazine 20. The supplemental lamellas 18 thus form supplemental retaining means 19 of the bullets 21, increasing the security of the magazine 20 and freeing its movements in the space.

In particular, the supplemental lamellas 18 are apt to contrast the gravity force in case the magazine 20 is rotated with its upper open end 22U directed toward ground also when the interaction between the key element 14 and lock 15 maintains the spring element 25 in its compressed form and the bullets 21 away from the elastic closing lamellas 26.

The magazine 20 may also comprise a display 27 provided with a plurality of luminous LEDs 28 used to display information relating the use of a firearm comprising the magazine 20, such as a battery state, an ON/OFF status signal, a connected/not connected signal, to name few. In particular, one of the luminous LEDs 28 can be a numerical LED 29 showing a number of fired gunshots or a number of left bullets. Alternatively, a suitable combination of the luminous LEDs 28 can be used to show the number of fired gunshots or left bullets.

In this aim, the magazine 20 may further comprise an accelerometer, able to detect and provide data relating the movements of the magazine 20, in particular the sharp accelerations of the firearm comprising the magazine 20. The number of sharp accelerations can be used to indicate a number of fired gunshots and/or a number of left bullets on the display 27.

The display 27 can be associated to the lower face 22L of the case 22 of the magazine 20. Alternatively, the display 27 can be positioned in correspondence of a supplemental space of the magazine 20, being provided to house the intelligent locking system 10, thus optimizing the overall sizes of the magazine 20.

Alternatively, the display can comprise a not-luminous working mode, in particular being provided with a sound or vibration generator, that can be activated depending on the tactical scenario, so as to reduce the risk of a visual localization of the firearm's owner.

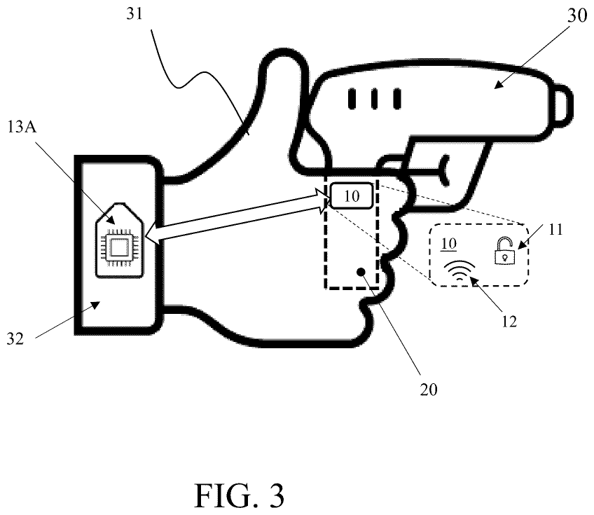

According to another embodiment, as shown in FIG. 3, the authorization command AC is provided to the locking element 11 of the intelligent locking system 10 by the user recognition device 12 after a user identification data 13 is received by an NFC or RFID tag 13A being a in the form of a wearable token 32 of an authorized user 31 which is holding a firearm 30 provided with a magazine 20 including the intelligent locking system 10 and thus being a controlled working repository 20.

According to a further embodiment, the controlled working repository 20 could also comprise a tracking system (not shown in the figures), being in the form of a microdevice, in particular based on low consumption technology, such a the BLE and NFC-RFID technologies. More particularly, such a tracking system could be housed in the NFC or RFID tag 13A.

In this way, a real time tracking of the firearm including the magazine 20 as controlled working repository could be effectively performed, each firearm being identified thanks to a unique code stored into a micro-tag housed into the magazine, also based on the NFC-RFID technology and able to communicate to other NFC-RFID receivers. For instance, such an NFC-RFID receiver could be associated to an entry point of a restricted/sensitive area, so as to monitor the number of firearm being in the area.

Thanks to the use of a tracking system, a controlled working repository 20 with the intelligent locking system 10 has two main application domains: private domain and public domain.

According to the private domain, the intelligent locking system 10 is designed to be used by the so called “good family father”, i.e. someone who wants to secure/increase the level of safety in the management of their potentially dangerous devices, in particular firearms, in order to avoid accidents, theft and use by unauthorized persons, including young family members.

According to a first function referred to as “unauthorized use”, the intelligent locking system 10 is able to promptly notify the owner when the firearm associated with the intelligent locking system 10 is removed or, more generally, is moved from a designated storing spot within an authorized area.

This feature allows an owner to track a firearm which is possession of unauthorized people, for instance in case of a member of the family or a theft, who has taken the firearm as well as the corresponding NFC or RFID tag 13A which authorize its use.

Similarly, the tracking system can be used to track an operator of a private firm, such as a security firm, being provided with a firearm having a magazine which is a controlled working repository 20 with an intelligent locking system 10.

The same need of tracking a controlled working repository 20 can rise in case of a dangerous tool which can be only handled by specialized users.

Furthermore, in particular in military applications, it is possible to monitor a single weapon system or one of its components, a stock of weapons and equipment during a transfer and assignment step, a container, a transport carrier, a tactical system, a group of human resources, a team in operational deployment, etc. or identify and locate one or more weapons characterized by high offensive power so as to prevent their fraudulent use on a large scale.

The controlled working repository 20 with the intelligent locking system 10 can be also provided with further microdevices being able to implement other functionalities, such as a gyroscope, an oscillometer, an accelerometer or a GPS system as well as a memory block, so that the controlled working repository 20 can be used as a “black box” storing a plurality of data that can be used to check the working or use of the tool or firearm associated to the controlled working repository 20.

Finally, the controlled working repository 20 can be provided with an anti-tampering device, which prevent the removal of the same from the tool or firearm by an unauthorized user.

In summary, the intelligent locking system comprising a locking element driven by an authorization command issued by a user recognition device only after recognition of authorized user(s) guarantees a safe use of dangerous tools, in particular firearms.

It is underlined that the described intelligent locking system is economically advantageous since it does not involve structural changes to the firearm or its firing mechanisms. Similarly, no structural modifications are needed to a tool distributing dangerous material or nails or to its dispensing mechanism.

In the case of weapons, the proposed intelligent locking system has no repercussions even from a law point of view.

It is equally important to underline that the intelligent locking system according to the embodiments of the disclosure applies to a large number of tools and weapons; in particular the preferred embodiment as above described can be associated to all devices that use a magazine with a forklift mechanism. Moreover, it is immediate to verify that the magazine with the intelligent locking system as above described can be associated to any kind of firearms, shotguns or rifles.

It is also noted that the intelligent locking system as described is totally reliable in all conditions of use of the tool or firearm, even in extreme conditions, in particular when associated with the wearable token.

It is well known that a firearm is configured, in the private field, as a personal defense object (or a sport or collection item) while in the military field, a firearm has usually an offensive and tactical aim. However, in both fields, a firearm should always be efficient, immediately usable for firing, easy to handle and reliable.

This main features can be jeopardized when using a fingerprint recognition device on board of the firearm during its working phase. In particular, a firearm operator usually wears tactical gloves or can have dirty or even injured hands being thus unable to use the finger or hand for the biometric authorization. Furthermore, adverse meteorological conditions, could prevent a proper working of a fingerprint sensor or a facial detector. The intelligent locking system associated to a magazine of a firearm allows to overcome all the above highlighted problems, still allowing the use of fingerprints as identification elements, further allowing voice biometric recognition as well as the use of an NFC or RFID tag, without intervening on the firing mechanisms of the firearms.

Hence, it is immediately evident that the proposed intelligent locking system can also be associated with already existing tools or firearms, being also completely reversible, without structurally modifying the same.

From the foregoing it will be appreciated that, although specific embodiments of the disclosure have been described herein for purposes of illustration, various modifications may be made without deviating from the spirit and scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An intelligent locking system configured to be associated to a controlled working repository comprising:
a locking element apt to physically prevent a proper working of the controlled working repository; and
a user recognition device apt to recognize an authorized user;
the locking element being triggered into a safe use mode only upon receiving an authorization command from the user recognition device, the safe use mode releasing a plurality of dangerous item stored into the controlled working repository.

2. The intelligent locking system of claim 1, wherein the locking element comprises an element selected from a group consisting of: (i) an electromechanical lock driven by the authorization command issued by the user recognition device, the electromechanical lock being associated with a release mechanism of the dangerous items stored in the controlled working repository; and (ii) a plurality of mechanical locks associated to each of the dangerous items to prevent their movement, being in the form of springs and barrels activated by the authorization command.

3. The intelligent locking system of claim 1, wherein the user recognition device is a biometric identification engine, being able to recognize the authorized user by means of their biometric data.

4. The intelligent locking system of claim 3, wherein the user recognition device comprises at least one between a voice recognition device and a fingerprint scanner.

5. The intelligent locking system of claim 1, wherein the user recognition device is apt to recognize a plurality of authorized users.

6. The intelligent locking system of claim 3, wherein the user recognition device comprises an interface apt to collect the biometric data of the user and a memory unit, able to store biometric data of authorized users.

7. The intelligent locking system of claim 6, wherein the user recognition device further comprises an engine being connected to the interface and to the memory unit and apt to compare collected biometric data with stored data so as to identify a user as an authorized user.

8. The intelligent locking system of claim 7, wherein the engine uses Machine Learning and Deep Learning algorithms to identify authorized users.

9. The intelligent locking system of claim 1, wherein the user recognition device is configured to send the authorization command to the locking element only after a user has been positively identified as an authorized user, the authorization command allowing unlocking the locking element by triggering the safe use mode.

10. The intelligent locking system of claim 9, wherein the user recognition device is a voice recognition device and a specific voice command is required from an authorized user to provide the first authorization command.

11. The intelligent locking system of claim 1, wherein the user recognition device is a portable device and comprises radio connection means to provide user identification data to the user recognition device.

12. The intelligent locking system of claim 11, wherein the portable device is an NFC or RFID tag.

13. A controlled working repository comprising:
a plurality of dangerous item;
at least a case having a closed end and an open end and being apt to house the plurality of dangerous item; and
an intelligent locking system,
wherein the intelligent locking system includes:
a locking element apt to physically prevent a proper working of the controlled working repository; and
a user recognition device apt to recognize an authorized user,
the locking element being triggered into a safe use mode only upon receiving an authorization command from the user recognition device, the safe use mode releasing the plurality of dangerous items.

14. The controlled working repository of claim 13, wherein the intelligent locking system is housed in the case.

15. The controlled working repository of claim 13, further comprising one or more of the elements selected from a group consisting of: (i) elastic means being able to move the dangerous items towards the open end of the case; (ii) elastic retaining means being able to keep the dangerous items in the case and being in the form of elastic closing lamellas which are opened by a suitable force applied by the elastic means; (iii) elastic means being able to move the dangerous items towards the open end of the case and elastic retaining means being able to keep the dangerous items in the case and being in the form of elastic closing lamellas which are opened by a suitable force applied by the elastic means.

16. The controlled working repository of claim 13, wherein the locking element comprises an element selected from a group consisting of: (i) an electromechanical lock associated with a release mechanism of the dangerous items attached to the closed end of the case, (ii) an electromechanical lock associated with a release mechanism of the dangerous items attached to the closed end of the case and chosen among an electronic lock, an electromagnetic lock and a magnetic lock; (ii) a plurality of mechanical locks associated to each of the dangerous items to prevent their movement within the case and being in the form of springs and barrels activated by the authorization command.

17. The controlled working repository of claim 13, further comprising an additional element selected from a group consisting of: (i) a circuital block provided with a battery; (ii) a circuital block provided with a battery housed in a fixed base; (iii) supplemental retaining means apt to keep the dangerous items within the case when the locking element is not in the safe use mode.

18. The controlled working repository of claim 13, being a magazine of a firearm.

19. A magazine of a firearm comprising:
a plurality of bullets;
at least a case having a closed end and an open end and being apt to house the plurality of bullets;
a fixed base;
elastic means;
a follower associated to the fixed base by the elastic means,
wherein the magazine stores the bullets in at least a column starting from the follower and the elastic means are able to move the follower and thus the bullets towards the open end of the case; and
an intelligent locking system including:
a locking element apt to physically prevent delivery of the bullets; and
a user recognition device apt to recognize an authorized user,
the locking element being triggered into a safe use mode only upon receiving an authorization command from the user recognition device, the safe use mode releasing the plurality of bullets.

20. The magazine of claim 19, wherein the intelligent locking system comprises a release mechanism associated to the follower and coupled to an electromechanical lock retaining the follower at the fixed base and the elastic means in a compressed status.

21. The magazine of claim 20, wherein the electromechanical lock is chosen among an electronic lock, an electromagnetic lock and a magnetic lock.

22. The magazine of claim 19, further comprising one or more elements selected from a group consisting of: (i) elastic closing lamellas at the open end of the case; (ii) elastic closing lamellas at the open end of the case and a spring element coupled between the fixed base and the follower and apt to force the bullets against the elastic closing lamellas when in the safe mode; (iii) supplemental retaining means apt to keep the bullets within the case when the locking element is not in the safe use mode, wherein the supplemental retaining means are in the form of supplemental lamellas, being provided within the case in correspondence of a position of a last bullet when the elastic means are compressed, so as to avoid any undesired movement of the bullets toward the open end of the case when not in the safety mode; (iv) a circuital block provided with a battery and housed in the fixed base; (v) interlocking features being able to interact with corresponding elements provided in a handle of a firearm housing the magazine; (vi) a display to provide information relating the use of a firearm comprising the magazine; (vii) a display to provide information relating the use of a firearm comprising the magazine with a plurality of luminous LEDs; (viii) a display to provide information relating the use of a firearm comprising the magazine with a plurality of luminous LEDs, wherein at least one of the plurality of luminous LEDs is a numerical LED; (ix) a display to provide information relating the use of a firearm associated to the closed end of the case; (x) a display to provide information relating the use of a firearm working in a not-luminous mode; (xi) an accelerometer, able to detect and provide data relating the movements of the magazine.

23. The magazine of claim 19, wherein the locking element comprises a plurality of mechanical locks associated to each of the bullets to prevent their movement within the case and being in the form of springs and barrels activated by the authorization command.
